(19) United States
(12) Patent Application Publication
(10) Pub. No.: US 2022/0388190 A1
(43) Pub. Date: Dec. 8, 2022

(54) VIBRATORY CUTTING SYSTEM

(71) Applicant: CORNING INCORPORATED, CORNING, NY (US)

(72) Inventors: Alejandro Aguilar, Painted Post, NY (US); Kevin Eugene Elliott, Horseheads, NY (US); Justin Carl Fossum, Horseheads, NY (US)

(21) Appl. No.: 17/824,014

(22) Filed: May 25, 2022

Related U.S. Application Data
(60) Provisional application No. 63/195,873, filed on Jun. 2, 2021.

(51) Int. Cl. B26D 1/06

(52) U.S. Cl. CPC B26D 1/06

(57) ABSTRACT

Systems and methods for cutting through one or more extrudates to form one or more honeycomb bodies are provided. The systems described herein provide a low inertia vibratory cutting system configured to cut through extrudate to form honeycomb bodies, where the vibratory cutting system comprises a thin, low-inertia cutting element, and one or more sets of fluid bearings configured to mitigate or lessen out of plane vibrations of the cutting element to provide a more stable cutting element. In some examples the vibratory cutting system comprises two sets of fluid bearings arranged at two locations on the cutting element that are configured to mitigate out-of-plane vibrations on the cutting element and between the two locations. In some examples, the cutting element is double-sided to allow for single-sided or double-sided cutting operations.

### CROSS-REFERENCE TO RELATED APPLICATION

This application claims the benefit of priority under 35 U.S.C. § 119 of U.S. Provisional Application Ser. No. 63/195,873 filed on Jun. 2, 2021 the content of which is relied upon and incorporated herein by reference in its entirety.

### FIELD OF THE DISCLOSURE

The present disclosure is directed generally to vibratory cutting systems, specifically to vibratory cutting systems with low inertia, and more specifically to low inertial vibratory cutting systems for cutting honeycomb bodies.

### BACKGROUND

Honeycomb bodies are used in a variety of applications, such as the construction of particulate filters and catalytic converters that treat unwanted components in a working fluid, such as pollutants in a combustion exhaust. The manufacture of honeycomb bodies can include extrusion of an extrudate material through one or more extrusion dies of an extrusion machine. Once extruded the extrudate is cut to a desired length.

### SUMMARY OF THE DISCLOSURE

The present disclosure provides systems and methods for cutting through one or more extrudates to form one or more honeycomb bodies. Specifically, the systems described herein provide a vibratory cutting system configured to cut through extrudate to form honeycomb bodies, where the vibratory cutting system comprises a thin, low-inertia, cutting element, and one or more sets of fluid bearings configured to mitigate or lessen out-of-plane vibrations of the cutting element to provide a more stable cutting element. In some examples the vibratory cutting system comprises two sets of fluid bearings arranged at two locations on the cutting element that are configured to mitigate out-of-plane vibrations on the cutting element and between the two locations. In some examples, the cutting element is double-sided to allow for single-sided or double-sided cutting operations.

In an example, a system for vibratory cutting is provided, the system comprising: a first actuator configured to generate a minor axial movement along an axial direction; a frame connected to the first actuator; a cutting element secured to the frame and configured to receive the minor axial movement and oscillate axially in response to the minor axial movement within a cutting plane, and wherein the cutting element is secured between a first portion of the frame and a second portion of the frame; and wherein the first actuator, the frame, and the cutting element are configured to translate in a major axial movement wherein the major axial movement is substantially parallel with the axial direction.

In an aspect, the apparatus comprises a support plate and at least one set of fluid bearings, wherein the first actuator and the at least one set of fluid bearings are connected to the support plate and wherein the at least one set of fluid bearings are configured to exert fluid pressure on a first side face and a second side face of the cutting element to constrain vibrations of the cutting element outside of the cutting plane.

In an aspect, the apparatus further comprises a second actuator configured to axially translate the frame, the support plate, the at least one set fluid bearing, and the cutting element in the major axial movement.

In an aspect, the cutting element comprises a first contact edge and a second contact edge, the first contact edge diametrically opposed to the second contact edge with respect to a width of the cutting element, such that the cutting element is configured for double-sided cutting operations in response to the major axial movement of the second actuator.

In an aspect, the second actuator is configured to impart a major transverse movement wherein the major transverse movement is substantially orthogonal to the major axial movement.

In an aspect, the frame is a shaped as a square, a rectangle, or a semi-circle.

In an aspect, the at least one set of fluid bearing comprises a first set of fluid bearings secured at a first location along a length of the cutting element and a second set of fluid bearings secured at a second location along the length of the cutting element.

In an aspect, the at least one set fluid bearings are secured directly to at least a portion of the frame.

In an aspect, the cutting element comprises a plurality of layered blades and wherein at least one layered blade of the plurality of layered blades comprises at least one projection; or wherein at least one layered blade of the plurality of layered blades comprises a variable width, wherein the variable width changes along a length of the cutting element.

In an aspect, the system is a low interial system defined by the relationship: M=500e^{-0.004f}+1.216, where M is a combined mass of the frame and cutting element and f is the frequency of vibratory oscillation and wherein M is selected from within the range of 0 kg to 500 kg and f is selected from within the range of 5 Hz to 1000 Hz.

In an aspect, the system is a low interial system defined by the relationship:

$$M = \frac{P}{{A}^{2} 4 {π}^{3} {f}^{3}} ,$$

where M is the combined mass of the frame and the cutting element, A is the displacement of at least the cutting element, P is the power at a tip of the cutting element, and f is the frequency of vibratory oscillation; and wherein M is selected from within a range of 0 kg to 500 kg; P is selected from within a range between 0 watts and 20 kilowatts; A is selected from within a range between 0 mm and 3 mm; and f is selected from within the range of 5 Hz to 1000 Hz.

In an aspect, a first end of the cutting element is secured to a first tensioning bracket, the first tensioning bracket secured to the first portion of the frame; and wherein a second end of the cutting element is secured to a second tensioning bracket, the second tensioning bracket arranged to slidingly engage the second portion of the frame.

In another example, a system for cutting an extrudate is provided, the system comprising: a first actuator configured to generate a minor axial movement along an axial direction; a frame connected to the first actuator; a cutting element secured to the frame and configured to receive the minor axial movement and oscillate axially in response to the minor axial movement within a cutting plane, and wherein the cutting element is secured between a first portion of the frame and a second portion of the frame; and a second actuator configured to axially translate the frame and the cutting element in a major axial movement to cut the extrudate wherein the major axial movement is substantially parallel with the axial direction.

In an aspect, the system further comprises a support plate and at least one set of fluid bearings, wherein the first actuator and the at least one set of fluid bearings are connected to the support plate and wherein the at least one set of fluid bearings are configured to exert fluid pressure on a first side face and a second side face of the cutting element to constrain vibrations of the cutting element outside of the cutting plane.

In an aspect, the cutting element comprises a first contact edge and a second contact edge, the first contact edge diametrically opposed to the second contact edge with respect to a width of the cutting element, such that the cutting element is configured for double-sided cutting operations in response to the major axial movement of the second actuator.

In an aspect, the second actuator is configured to impart a major transverse movement wherein the major transverse movement is substantially orthogonal to the major axial movement.

In an aspect, the at least one set of fluid bearing comprises a first set of fluid bearings secured at a first location along a length of the cutting element and a second set of fluid bearings secured at a second location along the length of the cutting element.

In an aspect, the at least one set fluid bearings are secured directly to at least a portion of the frame.

In an aspect, a first end of the cutting element is secured to a first tensioning bracket, the first tensioning bracket secured to the first portion of the frame; and wherein a second end of the cutting element is secured to a second tensioning bracket, the second tensioning bracket arranged to slidingly engage the second portion of the frame.

In an aspect, the cutting element comprises a plurality of layered blades, wherein at least one layered blade of the plurality of layered blades comprises at least one projection and at least one layered blade of the plurality of layered blades comprises a variable width, wherein the variable width changes along a length of the cutting element.

In an aspect, the frame is a shaped as a square, a rectangle, or a semi-circle.

In an aspect, the system is a low interial system defined by the relationship: M=500e^{-0.004f}+1.216, where M is a combined mass of the frame and cutting element and f is the frequency of vibratory oscillation and wherein M is selected from within the range of 0 kg to 500 kg and f is selected from within the range of 5 Hz to 1000 Hz.

In an aspect, the system is a low interial system defined by the relationship:

$$M = \frac{P}{{A}^{2} 4 {π}^{3} {f}^{3}} ,$$

where M is the combined mass of the frame and the cutting element, A is the displacement of at least the cutting element, P is the power at a tip of the cutting element, and f is the frequency of vibratory oscillation; and wherein M is selected from within a range of 0 kg to 500 kg; P is selected from within a range between 0 watts and 20 kilowatts; A is selected from within a range between 0 mm and 3 mm; and f is selected from within the range of 5 Hz to 1000 Hz.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a perspective view of a vibratory cutting system according to the present disclosure.

FIG. 2A is a perspective view of a honeycomb body according to the present disclosure.

FIG. 2B is a side elevational view of a honeycomb body according to the present disclosure.

FIG. 3 is a side elevational view of a vibratory cutting system according to the present disclosure.

FIG. 4 is a schematic side elevational view of a vibratory cutting system according to the present disclosure.

FIG. 5 is a perspective view of a cutting element according to the present disclosure.

FIG. 6A is a perspective view of a cutting element taken in cross-section according to the present disclosure.

FIG. 6B is a perspective view of a cutting element taken in cross-section according to the present disclosure.

FIG. 7A is a top plan view of a blade of a cutting element according to the present disclosure.

FIG. 7B is a top plan view of a blade of a cutting element according to the present disclosure.

FIG. 7C is a top plan view of a blade of a cutting element according to the present disclosure.

FIG. 8 is a side view of a portion of a frame and tensioning bracket according to the present disclosure.

FIG. 9 is a from elevational view of a portion of a frame and tensioning bracket according to the present disclosure.

FIG. 10 is a schematic side elevational view of a vibratory cutting system according to the present disclosure.

FIG. 11 is a perspective view of a vibratory cutting system according to the present disclosure.

FIG. 12 is a perspective view of a vibratory cutting system according to the present disclosure.

FIG. 13 is a side elevational view of a vibratory cutting system performing a major translational motion according to the present disclosure.

FIG. 14A is a side elevational view of a vibratory cutting system according to the present disclosure.

FIG. 14B is a side elevational view of a vibratory cutting system according to the present disclosure.

FIG. 15 is a perspective view of a vibratory cutting system according to the present disclosure.

FIG. 16 is a front elevational view of a vibratory cutting system according to the present disclosure.

FIG. 17 is a top plan view of a vibratory cutting system according to the present disclosure.

FIG. 18 is a perspective view of a frame plate of a vibratory cutting system according to the present disclosure.

FIG. 19 is a graphical illustration of an analytical power curve and a simplified power curve defining a low inertial system according to the present disclosure.

### DETAILED DESCRIPTION OF EMBODIMENTS

The present disclosure provides systems and methods for cutting through one or more extrudates to form one or more honeycomb bodies. Specifically, the systems described herein provide a vibratory cutting system configured to cut through extrudate to form honeycomb bodies, where the vibratory cutting system comprises a thin, low-inertia, cutting element, and, in some embodiments, one or more sets of fluid bearings configured to mitigate or lessen out-of-plane vibrations of the cutting element to provide a more stable cutting element. In some examples the vibratory cutting system comprises two sets of fluid bearings arranged at two locations on the cutting element that are configured to mitigate out-of-plane vibrations on the cutting element and between the two locations. In some examples, the cutting element is double-sided to allow for single-sided or double-sided cutting operations.

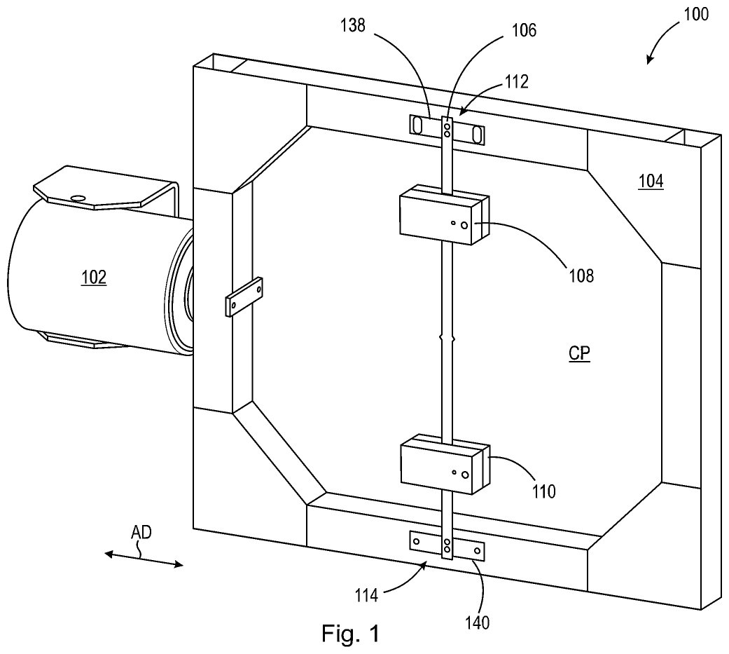

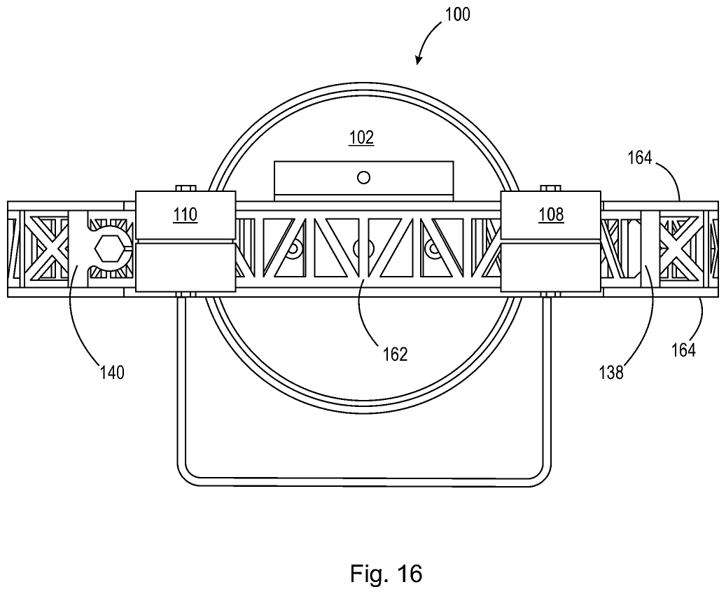

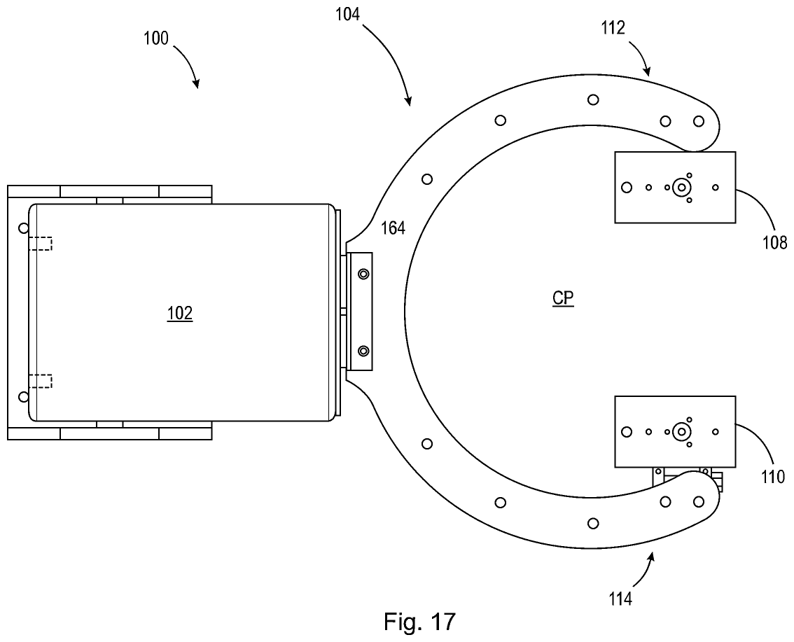

The following description should be read in view of FIGS. 1-18. FIG. 1 illustrates a front perspective view of an exemplary vibratory cutting system 100 according to the present disclosure. Vibratory cutting system 100 is intended to receive “green” extrudate, e.g., wet green extrudate, ultimately used to make honeycomb bodies referred to herein as honeycomb bodies HCB (or in the singular, “honeycomb body HCB”) via one or more extruding machines. In the examples described below, vibratory cutting system 100 is configured to cut through the entire diameter D1 of one or more extruded ceramic extrudates E created by the one or more extruding machines to form one or more honeycomb bodies HCB. In some examples, as will be discussed below, vibratory cutting system 100 is configured to employ double-sided cutting techniques to increase the rate at which the extrudate E is cut from the one or more extruding machines to form the green honeycomb bodies HCB.

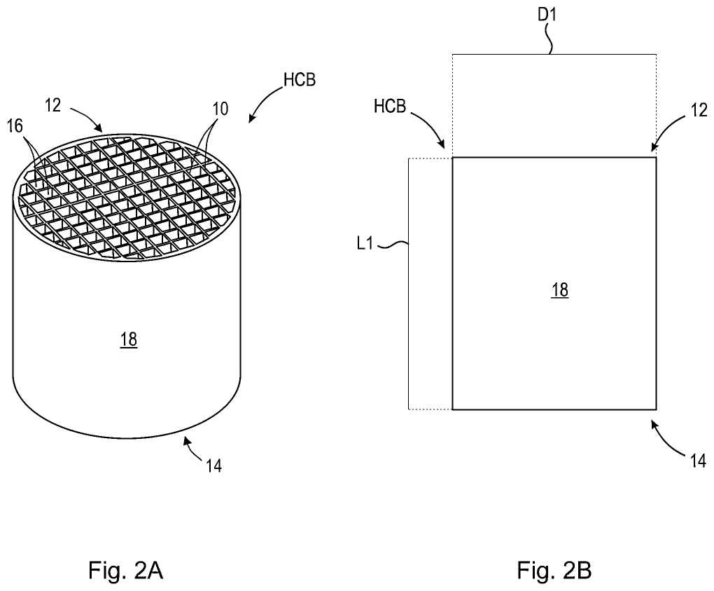

As shown in FIGS. 2A-2B, each honeycomb body HCB is generally formed from an extruded ceramic material. In some examples honeycomb body HCB comprises a plurality of intersecting inner walls 10 extending longitudinally through the length L1 of the honeycomb body HCB and from a first end 12 to a second end 14 of honeycomb body HCB. The inner walls 10 combine to define a plurality of channels, or cells 16, that form bores, or lumens, extending through honeycomb body HCB from the first end 12 to the second end 14 and form the cellular honeycomb construction of the extrudate E. In some examples, honeycomb body HCB, after firing, is constructed from porous ceramic materials. Accordingly, the extrudate referred to herein can be extruded from any suitable ceramic-forming batch mixture, such as a combination of inorganic particles, an organic binder, a liquid vehicle such as water, additives such as oils or lubricants, and/or pore formers. In some examples, an outer skin 18 surrounds the inner walls 10 and defines an outer circumferential surface of the honeycomb body HCB. The outer skin 18 refers to the circumferential surface that extends longitudinally between first end 12 and second end 14 of honeycomb body HCB. For ease of discussion herein, the term circumferential (and/or circumference) is used, however it should be appreciated that, in some examples, the honeycomb body HCB is formed in shapes other than cylindrical, and that the outer skin 18 is intended to refer to the outer peripheral surface of any such shape.

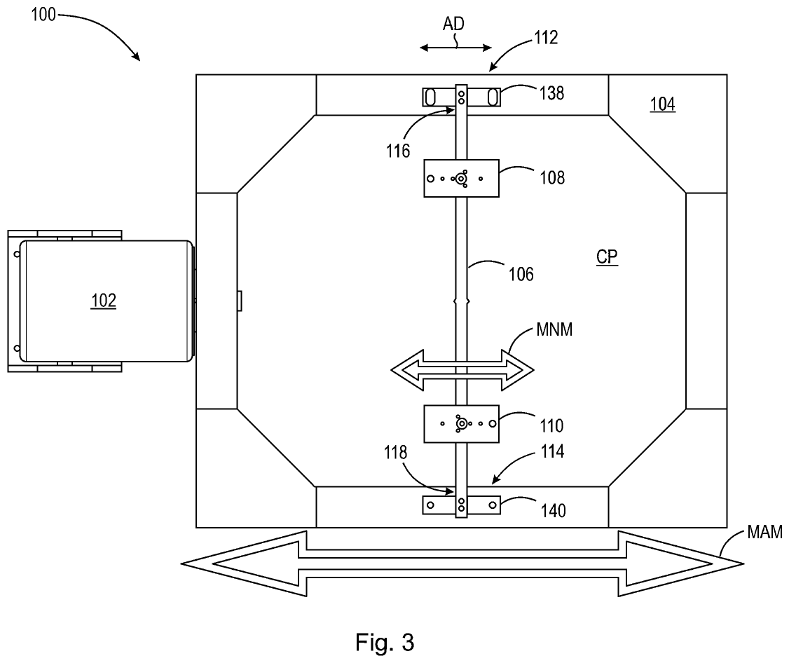

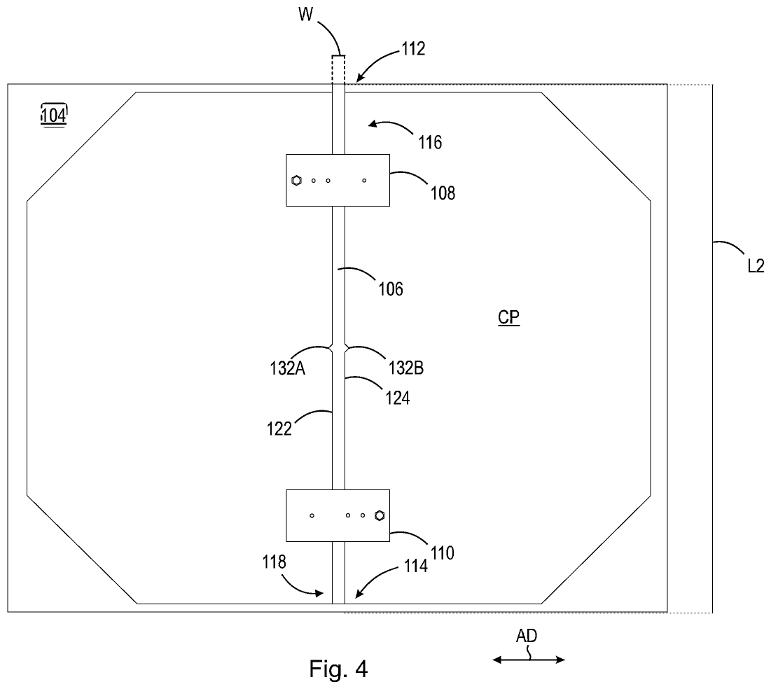

As illustrated in at least FIGS. 1 and 3, vibratory cutting system 100 comprises a first actuator 102, a frame 104, a cutting element 106, a first set of fluid bearings 108 and a second set of fluid bearings 110. FIG. 4 illustrates a simplified schematic side elevational view of these components without first actuator 102. First actuator 102 is intended to be a vibratory actuator configured to provide an oscillating vibratory motion along axial direction AD (e.g., left to right and right to left in FIG. 3). In some examples, the vibratory or oscillating motion along axial direction AD is referred to as a minor axial movement MNM (shown in FIG. 3). First actuator 102 comprises a body connected to a piston or arm configured to be fixedly secured to frame 104 such that any vibratory or oscillating movement generated between the actuator body and the piston or arm, i.e., minor axial movement MNM, is transferred to frame 104. In other words, the vibratory minor axial movement MNM generated by first actuator 102 is transferred to frame 104. The piston or arm of the first actuator 102 can be fixedly secured to the frame 104 via one or more fasteners or brackets, or can be integrally formed as a part of frame 104.

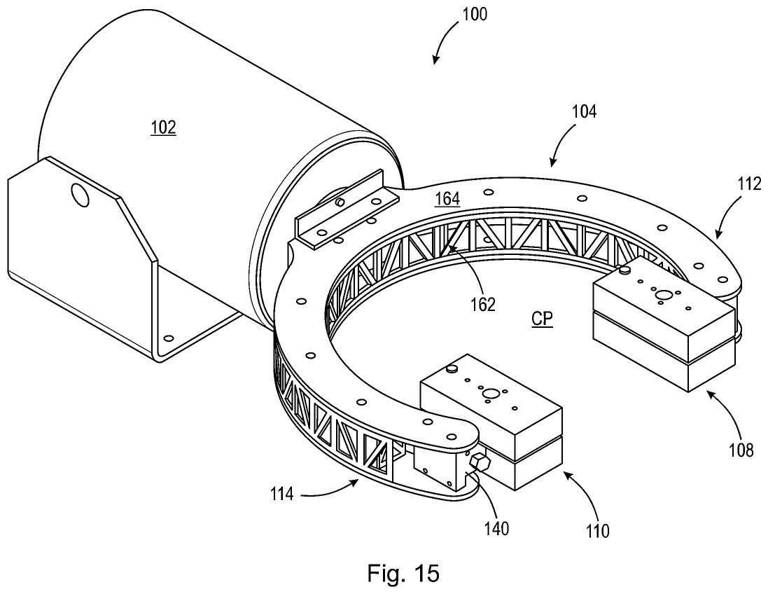

Frame 104 is intended to be a rigid structure configured to engage with a cutting element 106. As such, the vibratory minor axial movement MNM is transferred directly from the piston or arm of first actuator 102 to frame 104, and in turn imparted to cutting element 106 (discussed below). Frame 104 comprises at least a first portion 112 and a second portion 114, between which cutting element 106 is secured and supported. Frame 104 is intended to be made of a low-mass ridged material, e.g., steal, carbon fiber, or any other ridged structure capable of receiving and withstanding repeated oscillations or vibrations transferred from first actuator 102. In some examples, the material chosen for frame 104 is chosen for its total mass or its combined mass along with cutting element 106 (discussed below). As illustrated in FIGS. 1 and 3-4, in one example, frame 104 is a square or rectangular frame, configured to surround an area and define an imaginary plane (i.e., cutting plane CP) that is configured to receive a portion of an uncut extrudate E during operation of vibratory cutting system 100. As illustrated, cutting element 106 (discussed below) is secured and suspended between first portion 112 and second portion 114 of frame 104. In the examples shown, first portion 112 is intended to be a lateral member, e.g., a lateral portion of the square or rectangular frame arranged parallel with the minor axial movement MNM and perpendicular to the length of cutting element 106 during operation. Cutting element 106 is secured between the first portion 112 and the second portion 114. As illustrated, second portion 114 is also intended to be a lateral member, e.g., a lateral portion of the square or rectangular frame arranged parallel with the minor axial movement MNM and the first portion 112, and perpendicular to the length of cutting element 106 during operation. As illustrated in FIGS. 15-18 (discussed below) frame 104 can take other shapes, for example, frame 104 can include a frame 104 shaped as a circle, a semi-circle or half-circle, a rectangle, or a square. Additionally, in some examples frame 104 comprises one or more frame plates 164 (discussed below) separated by a truss structure 162 (also discussed below), where the one or more frame plates 104 and/or the truss structure 162 can be shaped as a semi-circle or half-circle (shown in FIGS. 15-18), and where the truss structure 162 is arranged between two of the one or more frame plates 164. In the examples discussed below, the truss structure 162 is welded along the perimeter of the top and bottom frame plates 164.

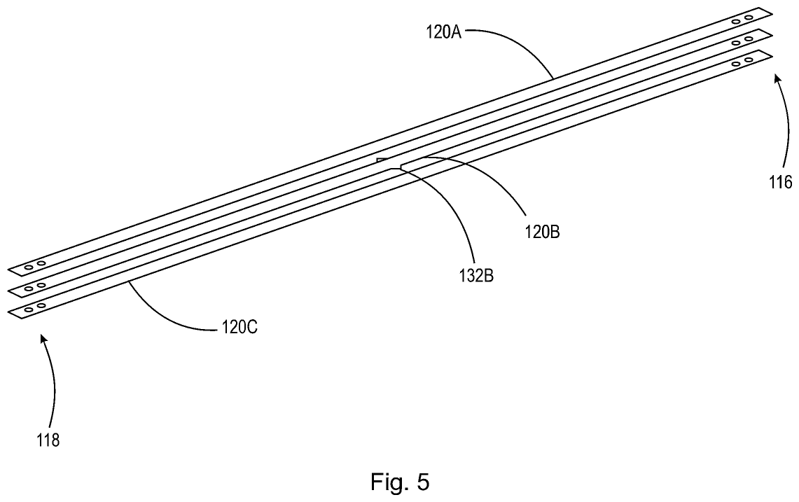

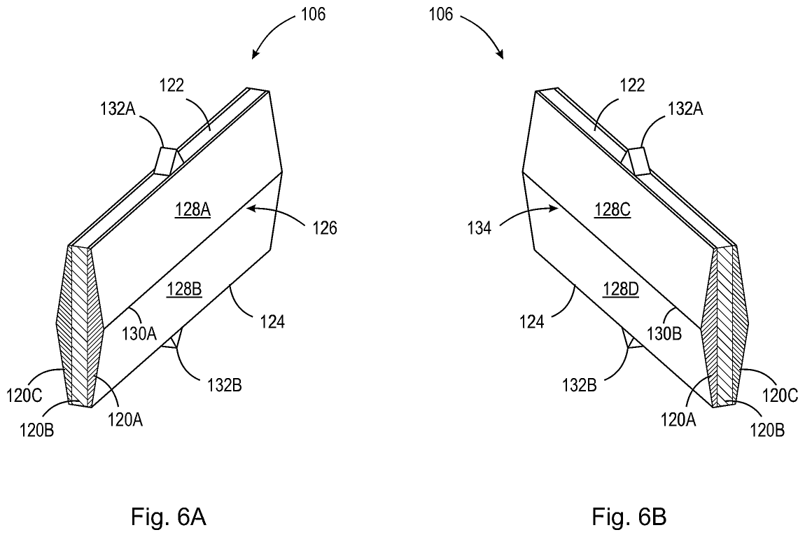

As illustrated in FIGS. 3-7B, cutting element 106 is intended to be a longitudinal piece of thin material, e.g., metal or other hardenable material with sufficient strength to withstand the axial cutting force imparted on cutting element 106 during the cutting operations discussed herein. The cutting element 106 comprises a first end 116 and a second end 118. By providing a thin cutting element, the total mass of the cutting element, and therefore the total mass of the system, can be reduced allowing for a low-inertial vibratory motion (described below). During operation of vibratory cutting system 100, first end 116 of cutting element 106 is configured to be connected to first portion 112 of frame 104 while second end 118 of cutting element 106 is intended to be connected to second portion 114 of frame 104. In some examples, as discussed below, first end 116 of cutting element is configured to be secured to a first tensioning bracket 138 (shown in FIGS. 1, 3, and 8-9) while second end 118 of cutting element 106 is configured to be secured to a second tensioning bracket 140 (shown in FIGS. 1 and 3). In some examples, cutting element 106 can be a single unitary cutting blade (as illustrated in FIGS. 1 and 3) or a plurality of blades 120 (shown in FIGS. 5-7C discussed below). As shown in general cross-section in FIGS. 6A and 6B, in an assembled state (discussed below), cutting element 106 has a first contact edge 122 and a second contact edge 124 configured to contact and cut through the extrudate E to form the honeycomb bodies HCB discussed herein.

As illustrated in FIG. 5, cutting element 106 can include a plurality of blades 120A-120C (collectively referred to herein as “blades 120” or “plurality of blades 120”) that are stacked on each other to form a single cutting element 106. For example, FIG. 5 illustrates a first blade 120A, a second blade 120B, and a third blade 120C of cutting element 106 in an exploded or expanded state. During operation, each of these blades 120 are placed in contact with each other forming a single, sandwiched, cutting element 106 as shown in FIGS. 6A-6B. FIGS. 6A-6B illustrate a front left and a front right perspective view, respectively, of a portion of cutting element 106 taken in cross-section generally through cutting element 106 in an assembled state. As shown in FIGS. 5-6B, first blade 120A is a substantially planar member disposed between first end 116 and second end 118 of cutting element 106 and comprises a first side face 126. First side face 126 comprises at least one side face surface, e.g., first side face surface 128A. In some examples, as illustrated in FIG. 6A, first side face 126 comprises two side face surfaces, e.g., first side face surface 128A and second side face surface 128B, separated by a first medial ridge 130A.

Second blade 120B is a substantially planar member disposed between first end 116 and second end 118 and comprises at least one projection 132A. Projection 132A is intended to be a tooth or other pointed projection and is configured to pierce, score, or otherwise cut outer skin 18 of an extrudate E during the cutting processes described herein. In the examples illustrated in FIGS. 5-7C, second blade 120B comprises two projections, i.e., first projection 132A and second projection 132B (collectively referred to herein as “projections 132”), arranged substantially equidistant from the first end 116 and the second end 118 of cutting element 106 and wherein the first projection 132A is arranged on first contact edge 122 extending in a direction parallel with cutting plane CP, while second projection 132B is arranged on second contact edge 124. In other words, as illustrated in FIGS. 5-6B, the first projection 132A and the second projection 132B are arranged on diametrically opposing sides of cutting element 106. Although illustrated as a triangular tooth or projection, it should be appreciated that projections 132 can be any shape or size that would concentrate the pressure or force generated by the minor axial moment MNM produced by first actuator 102 and transferred to cutting element 106 via frame 104. In some examples, projections can be circular, semi-circular, hexagonal, octagonal, or any other pointed shape configured to increase and concentrate the initial force of cutting element 106 onto extrudate E produced by the one or more extruding machines.

Additionally, third blade 120C is a substantially planar member disposed between first end 116 and second end 118 of cutting element 106 and comprises a second side face 134 (shown in FIG. 6B). Second side face 134 is diametrically opposed to first side face 126 and comprises at least one side face surface, e.g., third side face surface 128C. In some examples, as illustrated in FIG. 6B, second side face 134 comprises two side face surfaces, e.g., third side face surface 128C and fourth side face surface 128D, separated by a second medial ridge 130B.

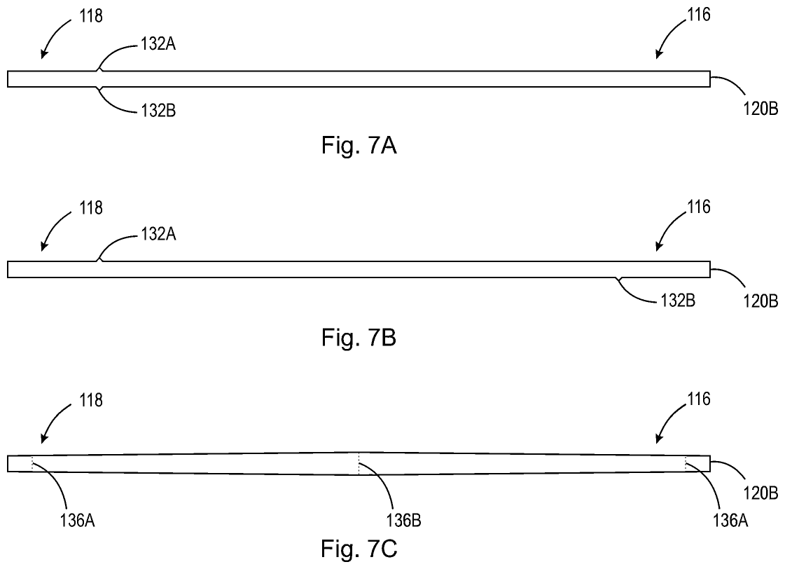

In some alternative examples, as illustrated in FIGS. 7A-7C, alternative blade configurations can be utilized when forming cutting element 106. For example, as shown in FIG. 7A, first projection 132A and second projection 132B of second blade 120B can both be positioned closer to second end 118 of cutting element 106 rather than substantially centered between the first end 116 and second end 118. Although not illustrated, it should be appreciated that both projections 132, i.e., first projection 132A and second projection 132B, can also be positioned closer to first end 116 of cutting element 106 rather than centered between the first end 116 and second end 118. Additionally, as shown in FIG. 7B, first projection 132A can be arranged proximate second end 118 of cutting element 106, while second projection 132B is arranged proximate first end 116 of cutting element 106. Although not illustrated, it should be appreciated that the inverse of the arrangement shown in FIG. 7B can be utilized, i.e., where first projection 132A is arranged proximate first end 116 while second projection 132B is arranged proximate second end 118. In another example shown in FIG. 7C, second blade 120B has a variable width 136 that forms a pointed portion substantially centered between first end 116 and second end 118 of cutting element 106. For example, as shown in FIG. 7C, second blade 120B tapers from a first width 136A proximate first end 116 to a second width 136B, where second width 136B is larger than first width 136A, and where the second width 136B is formed proximate the center of second blade 120B between first end 116 and second end 118 of cutting element 106. Additionally, second blade 120B also tapers from second width 136B proximate the center of second blade 120B back to first width 136A proximate second end 118 of cutting element 106. In other words, second blade 120B has a greater width proximate the center of second blade 120B and tapers to smaller widths proximate the first end 116 and second end 118. This tapered configuration results in a sharp or focused point proximate the center of second blade 120B that will aid in scoring or cutting through the extrudate E produced by the extrusion machines discussed herein.

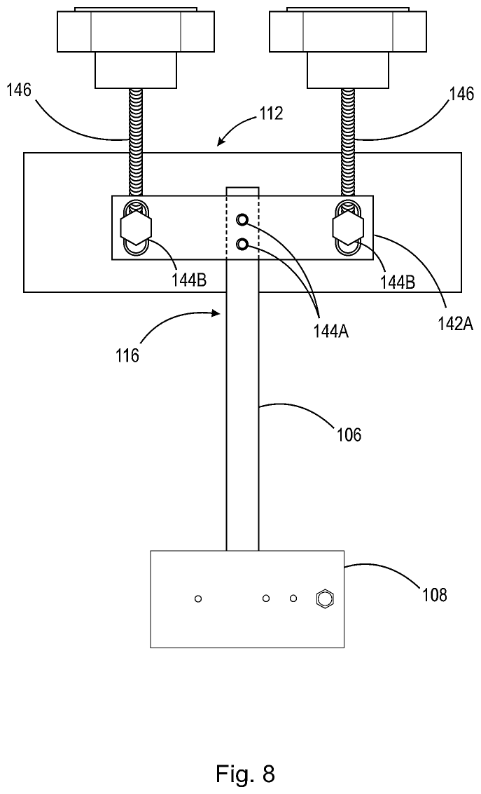

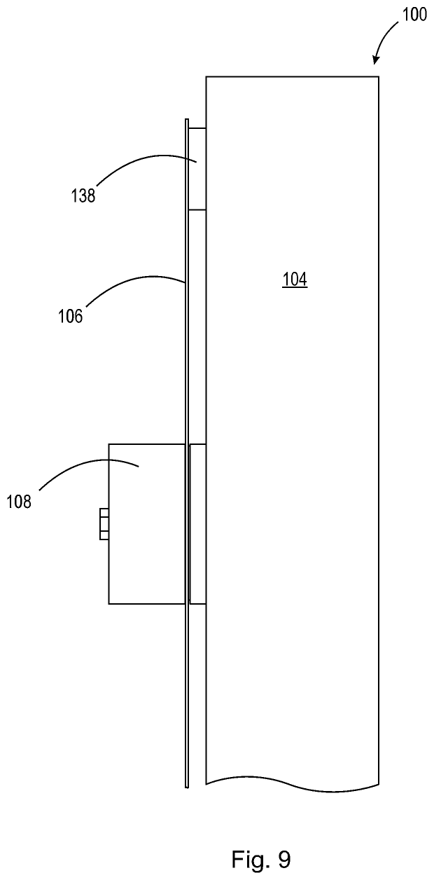

As illustrated in FIGS. 1, 3, and 8-9, and described above, cutting element 106 is secured between two portions of frame 104, via one or more tensioning brackets, e.g., first tensioning bracket 138 and second tensioning bracket 140. FIG. 8 illustrates a close up view of a first tensioning bracket 138, while FIG. 9 illustrates a front elevational view of a portion of frame vibratory cutting system 100. First tensioning bracket 138, shown in FIG. 8, is positioned on first portion 112 of frame 104 and comprises at least one bracket plate 142A, one or more securing fasteners 144A-B, and one or more tensioning fasteners 146. As shown in FIG. 8, first end 116 of cutting element 106 is secured to bracket plate 142A via two securing fasteners 144A and bracket plate 142A is secured to first portion 112 of frame 104 via two additional securing fasteners 144B. As shown, securing fasteners 144A are intended to be small diameter fasteners arranged along and substantially in line with the length of cutting element 106 and are configured to secure cutting element 106 to bracket plate 142A. In some examples, there is only one bracket plate 142A secured to cutting element 106 via securing fasteners 144A. In other examples, there are two bracket plates 142A, where one bracket plate 142A is positioned on either side of cutting element 106 and both bracket plates are secured to cutting element 106 via securing fasteners 144A. Additionally, the one or more bracket plates 142A also include one or more apertures configured to receive and slidingly engage with securing fasteners 144B. Securing fasteners 144B are intended to be larger diameter fasteners such as a hex bolt or other fastener and are arranged to extend through the one or more apertures of the one or more bracket plates 142A and secure directly to frame 104 providing a mechanical stop for the tensioning operation described herein.

Furthermore, the one or more bracket plates 142A include bores or through-bores configured to engage with a threaded fastener, e.g., the one or more tensioning fasteners 146. As illustrated in FIG. 8, the one or more tensioning fasteners 146 are arranged parallel with the length of cutting element 106 and are secured or anchored to frame 104 such that, upon turning each tensioning fastener 146, the one or more bracket plates 142A is/are pulled or pushed in a direction parallel with the length of cutting element 106. In other words, as tensioning fasteners 146 are rotated in a first direction (e.g., clockwise), the one or more bracket plates 142A are pulled in a first direction, e.g., upward in FIG. 8 toward first portion 112 of frame 104, thus increasing the overall tension on cutting element 106. Conversely, as tensioning fasteners 146 are rotated in a second, opposite, direction (e.g., counter-clockwise), the one or more bracket plates 142A are pushed in a second direction, e.g., downward in FIG. 8 and toward second portion 114 (shown in FIG. 1) of frame 104, thus decreasing the overall tension on cutting element 106. Although illustrated as knob-screws, it should be appreciated that any type of threaded fastener that would allow for the rotations and increases and decreases in tension of cutting element 106 discussed above can be utilized. As shown in FIG. 9, which illustrates a side elevational view of vibratory cutting system 100, by securing cutting element 106 to the outer surface of frame 104, e.g., at first portion 112 and second portion 114, cutting element 106 is suspended outside of the plane of frame 104 such that cutting plane CP described above is outside of the plane of frame 104.

As shown in FIGS. 1 and 3, vibratory cutting apparatus 100 also comprises second tensioning bracket 140. During operation, second tensioning bracket 140 is positioned on second portion 114 of frame 104 and comprises at least one bracket plate 142B and one or more securing fasteners 144. As shown in FIGS. 1 and 3, second end 118 of cutting element 106 is secured to bracket plate 142B via two securing fasteners 144 and bracket plate 142B of second tensioning bracket 140 is secured to second portion 114 of frame 104 via two additional securing fasteners 144. As shown, securing fasteners 144 are intended to be small diameter fasteners arranged along and substantially in line with the length of cutting element 106 and are configured to secure the cutting element 106 to one or more bracket plate 142B of second tensioning bracket 140. In some examples, there is only one bracket plate 142B secured to cutting element 106 via securing fasteners 144. In other examples, there are two bracket plates 142B, where one bracket plate 142B is positioned on either side of cutting element 106 and both bracket plates are secured to cutting element 106 via securing fasteners 144. In some examples the one or more bracket plates 142B are intended to be fixedly secured to second portion 114 of frame 104 such that they do not slidingly engage with frame 104, thus serving as an anchor point for the tensioning operation provided by first tensioning bracket 138 described above. However, it should be appreciated that, in some examples, second tensioning bracket 140 is substantially similar to first tensioning bracket 138 including all components and subcomponents described above such that tensioning operations are possible from either first tensioning bracket 138, second tensioning bracket 140, or both first tensioning bracket 138 and second tensioning bracket 140.

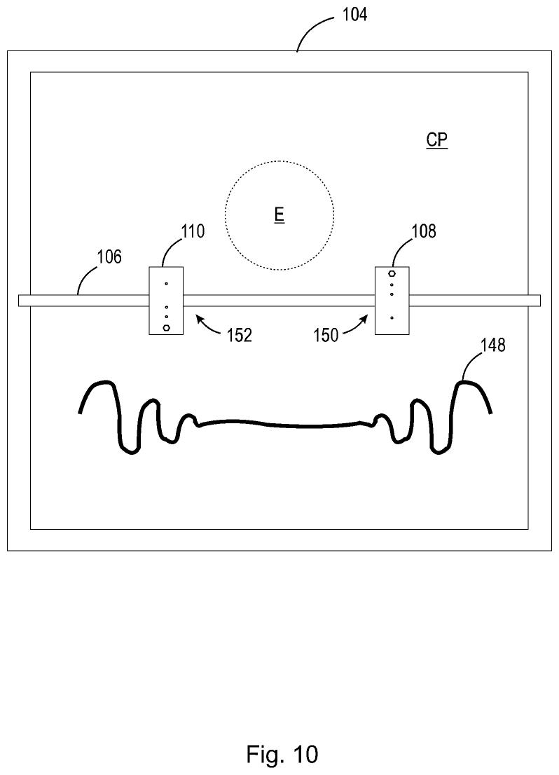

To reduce the out-of-plane vibrations 148 (shown in FIG. 10), vibratory cutting system 100 further comprises at least one set of fluid bearings, e.g., a first set of fluid bearings 108, positioned to apply a fluid pressure on the cutting element 106. The term “out-of-plane vibrations” as used herein, and in addition to its ordinary meaning to those in the art, is intended to mean modal vibrations of cutting element 106 in a direction orthogonal to the length L2 and width W of the cutting element, i.e., in and out of the page in FIG. 4. FIG. 10 illustrates a schematic plan view of the fluid bearings discussed herein and a schematic representation of the modal vibrations of cutting element 106 as well as the damping effect the bearings have on cutting element 106 during operation. First set of fluid bearings 108 is intended to be a set of non-contact fluid static bearings, e.g., are configured to apply a pressurized fluid against each side face (e.g., first side face 126 and second side face 128) of the cutting element 106 to maintain a fluid (e.g., air) gap between the first set of fluid bearings 108 and the cutting element 106. For example, the first set of fluid bearings 108 can apply pressure on the cutting element 106 in a direction orthogonal to the cutting plane CP in order to prevent out-of-plane vibrations 148 of cutting element 106. In some examples, the first fluid bearings 108 are arranged to apply pressure on both opposing side surfaces of cutting element 106, e.g., first side face 126 and second side face 128. In this way, the cutting element 106 can be axially stiffened via the application of pressure against the side faces (126,128) of the cutting element 106. By axially stiffening the cutting element 106, the number of out-of-plane resonant modes and/or the magnitude of out-of-plane vibrations 148 can be reduced or eliminated.

In some examples, shown in FIGS. 1, 3-4, and 10-14B, vibratory cutting system 100 comprises two sets of fluid bearings, i.e., first set of fluid bearings 108 and second set of fluid bearings 110. In examples with two sets of fluid bearings, first set of fluid bearings 108 are positioned at a first location 150 along cutting element 106 while second set of fluid bearings 110 are positioned at a second location 152 along cutting element 106, where the first location 150 is proximate first end 116 and second location 152 is proximate second end 118 of cutting element 106. As illustrated in FIG. 10, by positioning the two sets of fluid bearings at the first location 150 and second location 152, the out-of-plane vibrations 148 are significantly reduced or eliminated between the first location 150 and second location 152. As will be described below, during the cutting operations discussed herein, vibratory cutting system 100 is configured to apply a cutting force to the extrudate E produced by the one or more extruding machines such that the portion of cutting element 106 between first location 150 and second location 152 is the portion that contacts and cuts through the extrudate E to form the honeycomb bodies HCB discussed above.

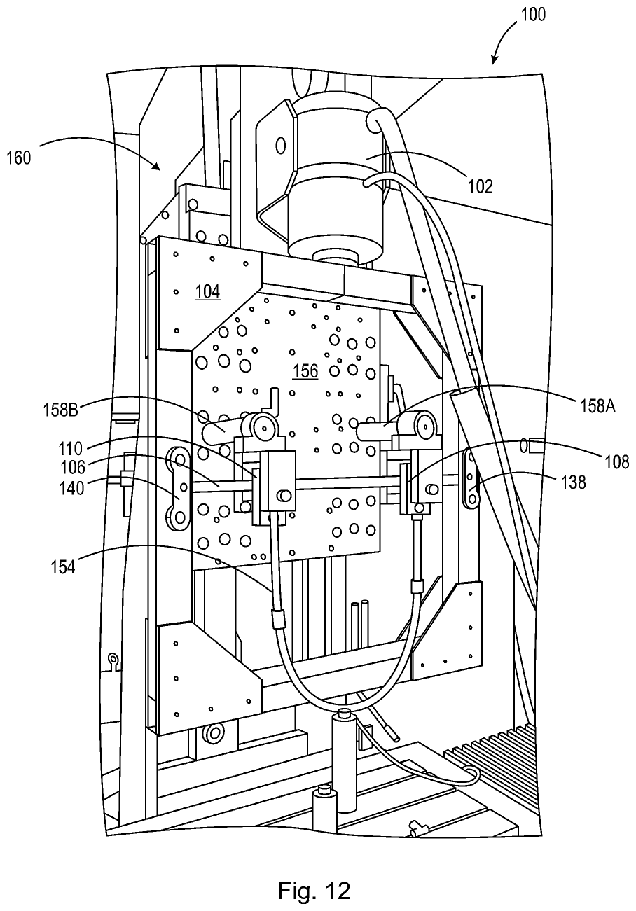

The sets of fluid static bearings discussed above can be in communication with a pressurized fluid source (not shown) via a conduit 154 (shown in FIG. 12) in order to apply a pressure against the surfaces of cutting element 106. The fluid source can comprise a pressurized tank or vessel, a pump, a compressor, or combinations thereof. The conduit 154 can comprise a fluid line or tube, as well as any couplings useful for delivering the pressurized fluid to the cutting element 106. In some examples, the first set of fluid bearings 108 and the second set of fluid bearings 110 (collectively referred to herein as “the fluid bearings”) are hydrostatic or aerostatic bearings, although any suitable liquid (e.g., oil) or gas (e.g., air, nitrogen, or other generally inert gases) can be used. In some examples, a gas such as air is utilized for the fluid bearings in order to avoid the need to handle (e.g., seal off and/or recirculate) a liquid, such as oil, as well as to minimize the potential effect the fluid media can have on the extrudate being cut (e.g., some liquids can weaken or otherwise impact the properties of a green ceramic honeycomb body HCB, such as the green strength or ability to dry or fire, if such liquids come into contact with the extrudate during cutting). In some examples, the fluid bearings comprise porous media bearings, although orifice bearings or other fluid static bearings can be used. In comparison to other types of bearings, such as mechanical bearings and/or fluid dynamic bearings that dissipate energy by damping vibrations, fluid static bearings can advantageously reduce out-of-plane vibrations 148 by providing stiffening of the cutting element 106, which conserves the vibrational energy by redirecting the energy axially, which results in increased efficiency of energy transmission through the cutting element 106.

In some embodiments, such as shown in FIG. 4, first set of fluid bearings 108 and second set of fluid bearings 110 span at least the entirety of the width W of the cutting element 106. However, pressure can be applied in other example embodiments over at least a portion of the width W of cutting element 106. In some example embodiments, the fluid bearings are stationary, such that the fluid bearings provide dynamic stiffening along at least a portion of the length L2 of the cutting element 106 as cutting element 106 is moved toward and/or through the extrudate discussed above in the axial direction AD. Additionally, although illustrated in FIGS. 1, 3-4, and 10-14B as comprising two sets of fluid bearings, i.e., first set of fluid bearings 108 and second set of fluid bearings 110, in some examples, vibratory cutting system 100 only comprises one set of fluid bearings 108.

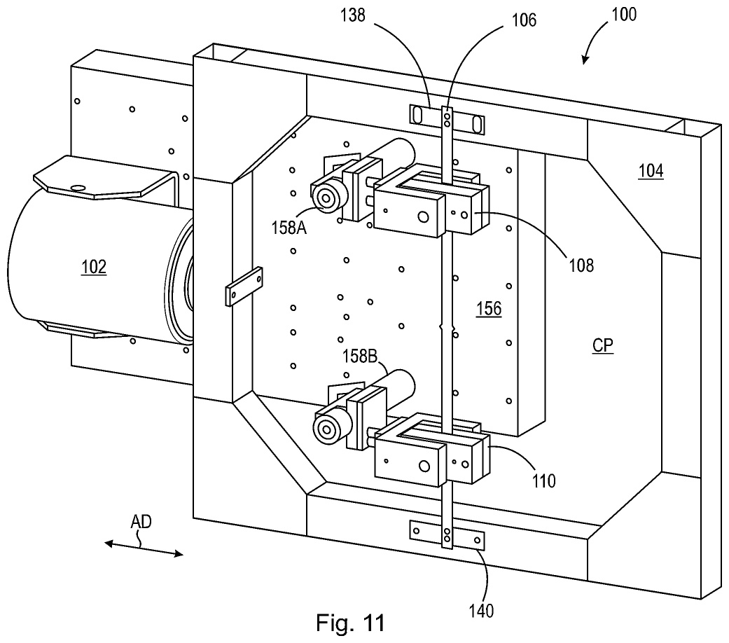

In some examples, as illustrated in FIG. 11, vibratory cutting system 100 comprises a support plate 156 and one or more support posts 158. As shown, support plate 156 is intended to be unitary body configured to be fixedly secured to at least first actuator 102 and the one or more support posts 158. Support plate 156 can be made of any suitable material with sufficient stiffness and structural integrity to withstand the vibratory motion of first actuator 102, e.g., the minor axial movement MNM. The one or more support posts 158 include at least a first support post 158A configured to support the first set of fluid bearings 108 proximate first location 150 along cutting element 106. As such, first support post 158A can include one or more brackets configured to secure first support post 158 to the first set of fluid bearings 108 without interfering with the first set of fluid bearings ability to mitigate, reduce, or eliminate out-of-plane vibrations 148 of cutting element 106 as discussed above. Similarly, in examples where vibratory cutting system 100 comprises two sets of fluid bearings, i.e., first set of fluid bearings 108 and second set of fluid bearings 110, at least one support post 158 comprises a first support post 158A and a second support post 158B. In these examples, first support post 158A is configured to secure to and support first set of fluid bearings 108 and second support post 158B is configured to secure to and support second set of fluid bearings 110. It should be appreciated that second set of fluid bearings 110 can include one or more brackets configured to secure second support post 158B to the second set of fluid bearings 110 without interfering with the first set of fluid bearings ability to mitigate, reduce, or eliminate out-of-plane vibrations 148 of cutting element 106 as discussed above.

In the examples illustrated in FIGS. 3 and 11-12, vibratory cutting system 100 also comprises a second actuator 160 (shown in FIG. 12) configured to impart at least a major axial movement MAM on the rest of the components of vibratory cutting system 100 as described above. For example, a second actuator 160 is fixedly secured to and arranged to translate at least frame 104, the support plate 156, at least one set fluid bearings, e.g., first set of fluid bearings 108, and cutting element 106 in a major axial movement MAM. In some examples where vibratory cutting system 100 comprises two sets of fluid bearings, i.e., first set of fluid bearings 108 and second set of fluid bearings 110 supported by first support post 158A and second support post 158B, respectively, second actuator 160 is configured to translate at least frame 104, the support plate 156, first support post 158A, second support post 158B, first set of fluid bearings 108, second set of fluid bearings 110, and cutting element 106 in a major axial movement MAM. As will be described in the operational examples below, during operation, first actuator 102 is configured to produce a vibratory axial motion of cutting element 106 (e.g., minor axial movement MNM) which generates the cutting force needed to cut through a given extrudate, while second actuator 160 is configured to translate cutting element 106 with a first major axial movement MAM1 through the entire diameter D1 of the given extrudate. For example, in embodiments where the extrudate E is approximately 15 cm (roughly 6 inches), the minor axial movement MNM can only be a few millimeters while the first major axial movement MAM1 is at least 15 cm to allow for a cutting motion through the entire diameter of the extrudate. As illustrated in FIG. 12, second actuator 160 can be supported by an external structure configured to support all of vibratory cutting system 100 and provide a major axial movement MAM in a vertical direction, e.g., up and down in FIG. 12, with respect to the floor beneath the system. In some embodiments, the magnitude to the major axial movement MAM (in either or both directions) is larger than the diameter D1 of the honeycomb body HCB, and at least 10 times, at least 50 times, at least 100 times, or even at least 500 times larger than the minor axial movement MNM, including ranges having these values as endpoints, such as from 10 times to 1000 times larger, from 50 times to 1000 times larger, or from 500 times to 1000 times larger. In some embodiments, the major axial movement MANI is at least 10 cm, such as from 10 cm to 50 cm, and the minor axial movement MNM is at most 10 mm, at most 5 mm, or even at most 1 mm, including ranges including these values as endpoints such as from 0.05 mm to 10 mm, from 0.05 mm to 5 mm, or from 0.05 mm to 1 mm.

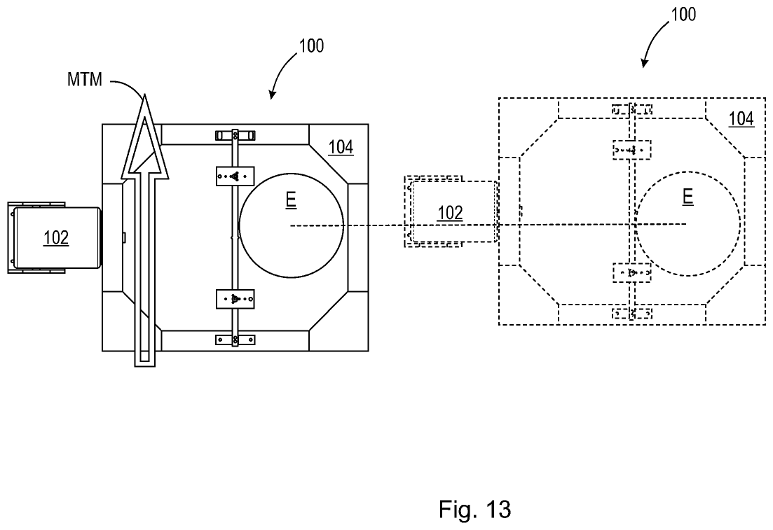

As described above with respect to FIGS. 5-7C, the blades 120 that comprise cutting element 106 can include one or more projections configured to concentrate the vibratory axial force imparted on the extrudate/honey comb body HCB to aid in scoring or otherwise piercing the outer skin 18 and help start the cutting process. However, in some examples, as illustrated in FIG. 13, in addition to or in place of these projections, second actuator 160 is further configured to impart a major translational movement MTM on rest of the components of vibratory cutting system 100 as described above. For example, a second actuator 160 is arranged to translate at least frame 104, support plate 156, first set of fluid bearings 108, and cutting element 106 in a major translational movement MTM where the major translational movement MTM is substantially orthogonal to the major axial movements MANI described above. Thus, as the cutting edge of cutting element 106 contacts the outer skin 18 of the extrudate, the vibrations of the minor axial movement MNM could be insufficient to pierce or score outer skin 18 and the translational motion provided by second actuator 160 through a major translational movement MTM causes the contact edges of cutting element 106 to slice through outer skin 18 helping to start the cutting process through the extrudate. Major translational movement MTM is illustrated in FIG. 13 with a dotted line showing the shift of the entire vibratory cutting system 100 with respect to the center point of a given extrudate.

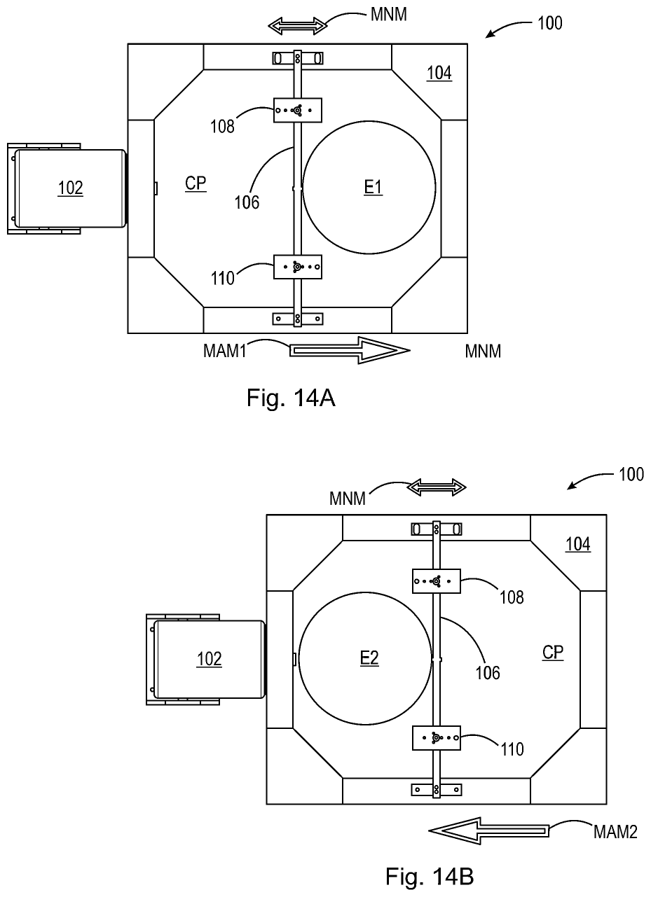

Additionally, as set forth above with respect to FIGS. 5-7C, cutting element 106 has two potential cutting edges, i.e., first contact edge 122 and second contact edge 124. By providing a double-edged or double-sided cutting element 106, while also providing a frame 104 with sufficient internal area to accommodate the diameters of two extrudates simultaneously, the vibratory cutting system 100 described herein can be utilized for single-sided cutting operations as well as double-sided cutting operations. For example, as shown in FIG. 14A, frame 104 is positioned with respect to the output of one or more extruding machines such that a first extrudate E1 is translated through cutting plane CP of vibratory cutting system 100 on the right side of cutting element 106 while also being within the boundaries of frame 104. In this position, second actuator 160 is configured to impart a first major axial movement MAM1, e.g., from left to right in FIG. 14A. During this first major axial movement MAM1, first actuator 102 is configured to generate and impart a vibratory cutting motion, e.g., minor axial movement MNM, on cutting element 106 to aid in cutting the first extrudate E1 while cutting element 106 translates through the entire diameter of the first extrudate E1. In this fully extended position, i.e., at the end of the first major axial movement MAM1, the output of the extruding machine places the next portion of extrudate, e.g., extrudate E2 on the left side of cutting element 106. Thus, on the reverse major axial movement, i.e., second major axial movement MAM2 (e.g., from right to left in FIG. 14B), the reverse motion provides a cutting motion of the second portion of extrudate, e.g., extrudate E2. Thus, by translating vibratory cutting system 100 in these two major axial movements, two cutting operations can be achieved before the system resets to its original starting position.

As illustrated in FIGS. 15-17, frame 104 can be shaped as a semi-circle or “C” shape. FIGS. 15-17 illustrate a front perspective view, a front elevational view, and a top plan view, respectively, of a vibratory cutting system 100 according to the present disclosure. As shown, frame 104 can include a truss structure 162 between one or more frame plates 164, where at least a portion of the truss structure 162 and/or at least a portion of the one or more frame plates 164 are fixedly secured to first actuator 102. Although not illustrated, and similar to the examples described above, a cutting element 106 can be secured or suspended between a first portion 112 of frame 104 and a second portion 114 of frame 104. In these examples, the first portion 112 comprises a first tensioning bracket 138 while second portion 114 comprises a second tensioning bracket 140. Unlike the examples described above, first tensioning bracket 138 is intended to be a fixed bracket, i.e., a bracket that fixedly secures a portion of cutting element 106 to first portion 112 of frame 104, while second tensioning bracket 140 is intended to rotatingly engage with cutting element 106 proximate second portion 114 of frame 104. For example, a portion of cutting element 106 can be fed through a slot or aperture of a rotational element within second tensioning bracket 140 such that rotation of the rotational element increases the tension on cutting element 106. It should be appreciated that in the examples illustrated, first tensioning bracket 138 and second tensioning bracket 140 are positioned between the two frame plates 164. Similarly, to the examples described above, two fluid bearings are provided, e.g., first set of fluid bearings 108 and second set of fluid bearings 110, where both sets of fluid bearings are secured to a support plate, e.g., support plate 156 (shown in FIG. 11), separate from frame 104. As discussed above, first actuator 102 is configured to generate a minor axial movement MNM of frame 104 and/or frame plates 164, which in turn creates the vibratory movement of cutting element 106 within the first and second sets of fluid bearings such that the fluid bearings mitigate or eliminate out of plane vibrations 148 of cutting element 106 between each set of fluid bearings.

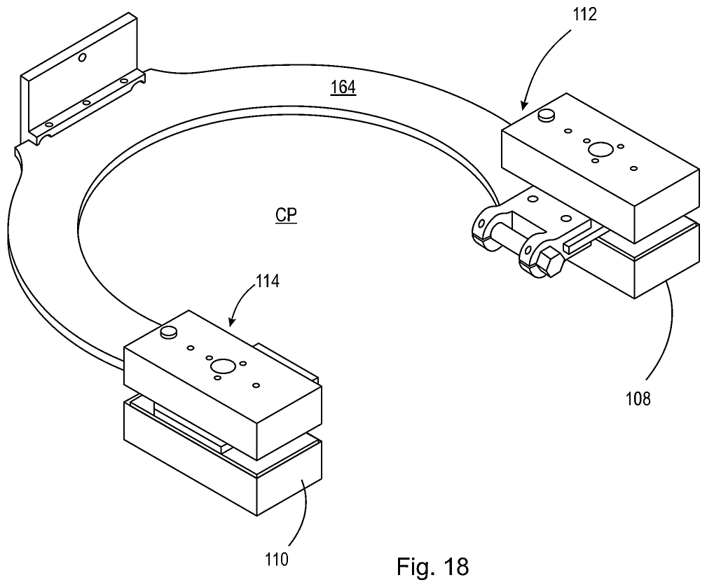

As illustrated in FIG. 18, in some examples, the first set of fluid bearings 108 and the second set of fluid bearings 110 are configured to secure and mitigate any out-of-plane vibrations 148 of at least one of the frame plate 164 that secures the cutting element 106, rather than only securing the cutting element 106 directly. In other words, the fluid bearings can be arranged to mitigate or eliminate out-of-plane vibrations 148 of the cutting element 106 by being positioned on the cutting element 106 directly (as shown in FIGS. 1, 3-5, 8-14B), or they can be placed on the one or more frame plates 164 used to support the cutting element 106 (as shown in FIG. 18). Both configurations serve to mitigate out-of-plane vibrations 148 of cutting element 106 during operation. As illustrated, the top halves of each set of fluid bearings can be secured to the one or more frame plates via a hinged connection to allow for the cutting element 106 to secure to the first portion 112 and second portion 114 of the frame plate 164.

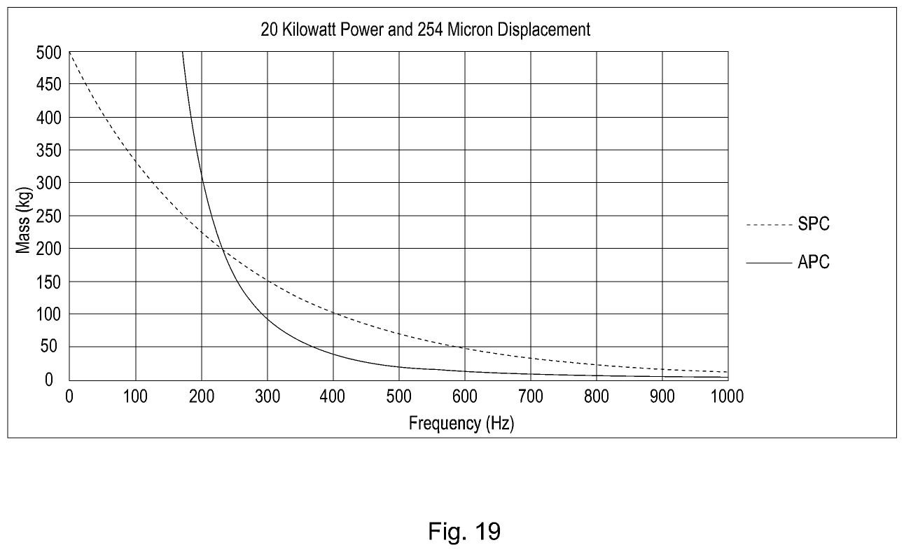

As illustrated in FIG. 19 and described above, the present vibratory cutting system 100 is intended to be a low inertia vibratory system. In other words, the materials, dimensions, and/or masses of at least some of the components discussed above are selected such that the minor axial movement MNM is optimized at a given power of the first actuator 102. In some examples, a “low inertial system” is defined by a polynomial equation that includes four variables, i.e., the combined mass M of at least the frame 104 and cutting element 106, the power P of the first actuator 102 (measured at a projection 132 or at the first or second contact edges (122,124)); the displacement A of the cutting element 106 during its vibratory oscillations, i.e., during the minor axial movement MNM; and, the frequency f of those oscillations. In some examples, each variable described above can selected from within a range of values, e.g., combined mass M is selected from within a range of 0 kg to 500 kg; power P is selected from within a range between 0 W (Watts) and 20 kW; displacement A is selected from within a range between 0 mm and 3 mm; and frequency f is selected from within the range of 5 Hz to 1000 Hz. In one example, a low inertial system as described herein is defined by the polynomial relationship shown by Equation 1 below.

$$M = \frac{P}{{A}^{2} 4 {π}^{3} {f}^{3}} \qquad Equation 1$$

As illustrated in FIG. 19, Equation 1 above can be bounded by constraining certain variables to comport with common use cases. For example, at a fixed power P and a fixed displacement A, e.g., where P is 20 kW (measured at the protrusions 132 and/or the contact edges (122,124) and A is 234 microns, an analytical power curve APC (illustrated by a solid curve line in FIG. 19) can be generated. Along this analytical power curve APC, there is an inverse relationship between combined mass M and frequency f of the vibratory oscillations described herein. As illustrated, any combination of values for M and f that would fall below the analytical power curve APC would be acceptable values to generate a low inertial system as described herein. For example, at a frequency f of 300 Hz, the combined mass M of the oscillating components should be less than or equal to approximately 92.5 kg. In another example, where M is known or fixed, e.g., at 50 kg, the frequency f selected should be less than or equal to approximately 368 Hz to maintain a low inertial system according to the present disclosure. It should be appreciated that equation 1 does not need to be bound by a fixed power P and/or a fixed displacement A and that each of the four variables of Equation 1 can be fixed and/or solved for to maintain a low interial system.

In some examples, Equation 1 above can be simplified to a binomial relationship shown by Equation 2 below. For example, by constraining Equation 1 to a fixed power P, e.g., a fixed power P between 10 kW and 20 kW, and a fixed displacement A of 254 microns, as well as bounding the resulting curve to show only combined masses between 0 kg and 500 kg and only frequencies between 0 Hz and 1000 Hz, Equation 1 can be simplified to Equation 2. Importantly, Equation 2 only comprises two variables, i.e., the combined mass M and frequency f.

M=500e^{-0.004f}+1.216 Equation 2:

By constraining the combined mass M to less than 500 kg, it is possible to eliminate or mitigate the asmtotic relationship illustrated by the APC curve to prevent a relatively infinite mass at lower frequencies. Additionally, the other variables, i.e., −0.004 and 1.216, were selected based on mathematical understandings of the relationship of variables in the exponential decay equation to try and best fit the APC curve.

As illustrated in FIG. 19, Equation 2 can be used to generate a simplified power curve SPC (illustrated by a dashed curve line in FIG. 19). Along this simplified power curve SPC, there is an inverse relationship between combined mass M and frequency f of the vibratory oscillations described herein. As illustrated, any combination of values for M and f that would fall below the simplified power curve SPC would be acceptable values to generate a low inertial system as described herein. For example, at a frequency f of 100 Hz, the combined mass M of the oscillating components should be less than or equal to approximately 335 kg. In another example, where M is known or fixed, e.g., at 100 kg, the frequency f selected should be less than or equal to approximately 405 Hz to maintain a low inertial system according to the present disclosure.

From the illustrated relationships shown in FIG. 19 and described above through Equations 1 and 2, some general points of commonality emerge. For example, in developing a low interial system, the combined mass M should be minimized as much as possible to reduce power consumption. Additionally, when frequency f is increased, power consumption also increases. Furthermore, as combined mass M increases, displacement A decreases at a fixed power P. Finally, if combined mass M is kept constant or fixed and displacement A is increased, power consumption also increases.

In one example, during operation, vibratory cutting system 100 is configured to perform a single-sided cutting operation of one or more extrudates to form one or more honeycomb bodies HCB. As described above, the one or more extruding machines are configured to extrude the ceramic extrudate material through one or more extruding dies to form an extrudate E capable of being cut to a required length by vibratory cutting system 100. The vibratory cutting system 100 can be positioned so as to receive the extrudate E through at least a portion of frame 104 and through a cutting plane CP of cutting element 106. Once extruded to the desired length, first actuator 102 is configured to generate and impart a vibratory cutting motion, e.g., minor axial movement MNM. First actuator 102 transmits these vibrations through first actuator 102 to frame 104, and frame 104 imparts this vibrational motion on cutting element 106 within cutting plane CP. While first actuator 102 generates the vibratory cutting motion on cutting element 106, second actuator 160 is configured to impart a first major axial movement MAM1 on frame 104 and therefore cutting element 106 (e.g., from left to right in FIG. 14A) so that second contact edge 124 of cutting element 106 contacts and cuts through extrudate E until cutting element 106 passes through the entire diameter of the extrudate E. Once in this fully extended position, second actuator 160 can provide a second major axial movement MAM2, e.g., from right to left in FIG. 14A, to bring frame 104 and cutting element 106 back to its original starting position to prepare to receive the next portion of extrudate for the next single-sided cutting operation.

In another example, vibratory cutting system 100 is configured to perform a double-sided cutting operation of one or more extrudates to form one or more honeycomb bodies HCB. As described above, the one or more extruding machines are configured to extrude the ceramic extrudate material through one or more extruding dies to form an extrudate E capable of being cut to a required length by vibratory cutting system 100. The vibratory cutting system 100 can be positioned so as to receive the extrudate E through at least a portion of frame 104 and through a cutting plane CP of cutting element 106. Once extruded to the desired length, first actuator 102 is configured to generate and impart a vibratory cutting motion, e.g., minor axial movement MNM. First actuator 102 transmits these vibrations through first actuator 102 to frame 104, and frame 104 imparts this vibrational motion on cutting element 106 within cutting plane CP. While first actuator 102 generates the vibratory cutting motion on cutting element 106, second actuator 160 is configured to impart a first major axial movement MAM1 on frame 104 and therefore cutting element 106 (e.g., from left to right in FIG. 14A) so that second contact edge 124 of cutting element 106 contacts and cuts through extrudate E1 until cutting element 106 passes through the entire diameter of the extrudate E1. Once in this fully extended position, second actuator 160 can provide a second major axial movement MAM2, e.g., from right to left in FIG. 14B, to translate frame 104 and cutting element 106 back to its original starting position. During this second major axial movement MAM2, first actuator 102 is configured to continue to generate and impart a vibratory cutting motion, e.g., minor axial movement MNM, on cutting element 106 to aid in cutting a second portion of extrudate E2 while cutting element 106 translates back through the entire diameter of the next portion of extrudate E2. During this second major axial movement MAM2, first contact edge 122 of cutting element 106 is configured to impulsively cut through the body of extrudate E2 until cutting element 106 has passed through the entire diameter of the extrudate freeing another portion of the extrudate that will become another honeycomb body HCB. Thus, by translating frame 104 in both directions, i.e., via first major axial movement MAM1 and second MAM2, both contact edges of cutting element 106 are used to create a double-sided cutting operation.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also comprising more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily comprising at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some examples, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A system for vibratory cutting comprising:
a first actuator configured to generate a minor axial movement along an axial direction;
a frame connected to the first actuator; and
a cutting element secured to the frame and configured to receive the minor axial movement and oscillate axially in response to the minor axial movement within a cutting plane, and wherein the cutting element is secured between a first portion of the frame and a second portion of the frame;
wherein the first actuator, the frame, and the cutting element are configured to translate in a major axial movement wherein the major axial movement is substantially parallel with the axial direction.

2. The system of claim 1, further comprising a support plate and at least one set of fluid bearings, wherein the first actuator and the at least one set of fluid bearings are connected to the support plate and wherein the at least one set of fluid bearings are configured to exert fluid pressure on a first side face and a second side face of the cutting element to constrain vibrations of the cutting element outside of the cutting plane.

3. The system of claim 2, further comprising a second actuator configured to axially translate the frame, the support plate, the at least one set fluid bearing, and the cutting element in the major axial movement.

4. The system of claim 3, wherein the cutting element comprises a first contact edge and a second contact edge, the first contact edge diametrically opposed to the second contact edge with respect to a width of the cutting element, such that the cutting element is configured for double-sided cutting operations in response to the major axial movement of the second actuator.

5. The system of claim 4, wherein the second actuator is configured to impart a major transverse movement wherein the major transverse movement is substantially orthogonal to the major axial movement.

6. The system of claim 1, wherein the at least one set of fluid bearing comprises a first set of fluid bearings secured at a first location along a length of the cutting element and a second set of fluid bearings secured at a second location along the length of the cutting element.

7. The system of claim 1, wherein the at least one set fluid bearings are secured directly to at least a portion of the frame.

8. The system of claim 1, wherein the cutting element comprises a plurality of layered blades and wherein at least one layered blade of the plurality of layered blades comprises at least one projection; or wherein at least one layered blade of the plurality of layered blades comprises a variable width, wherein the variable width changes along a length of the cutting element.

9. The system of claim 1 wherein the system is a low interial system defined by the relationship: M=500e^{-0.004f}+1.216, where M is a combined mass of the frame and cutting element and f is the frequency of vibratory oscillation and wherein M is selected from within the range of 0 kg to 500 kg and f is selected from within the range of 5 Hz to 1000 Hz.

10. The system of claim 1 wherein the system is a low interial system defined by the relationship: M=P/A₂4π³f³, where M is the combined mass of the frame and the cutting element, A is the displacement of at least the cutting element, P is the power at a tip of the cutting element, and f is the frequency of vibratory oscillation; and
wherein M is selected from within a range of 0 kg to 500 kg; P is selected from within a range between 0 watts and 20 kilowatts; A is selected from within a range between 0 mm and 3 mm; and f is selected from within the range of 5 Hz to 1000 Hz.

11. The system of claim 1, wherein a first end of the cutting element is secured to a first tensioning bracket, the first tensioning bracket secured to the first portion of the frame; and wherein a second end of the cutting element is secured to a second tensioning bracket, the second tensioning bracket arranged to slidingly engage the second portion of the frame.

12. A system for cutting an extrudate, comprising:
a first actuator configured to generate a minor axial movement along an axial direction;
a frame connected to the first actuator;
a cutting element secured to the frame and configured to receive the minor axial movement and oscillate axially in response to the minor axial movement within a cutting plane, and wherein the cutting element is secured between a first portion of the frame and a second portion of the frame; and
a second actuator configured to axially translate the frame and the cutting element in a major axial movement to cut the extrudate wherein the major axial movement is substantially parallel with the axial direction.

13. The system of claim 12, further comprising a support plate and at least one set of fluid bearings, wherein the first actuator and the at least one set of fluid bearings are connected to the support plate and wherein the at least one set of fluid bearings are configured to exert fluid pressure on a first side face and a second side face of the cutting element to constrain vibrations of the cutting element outside of the cutting plane.

14. The system of claim 12, wherein the cutting element comprises a first contact edge and a second contact edge, the first contact edge diametrically opposed to the second contact edge with respect to a width of the cutting element, such that the cutting element is configured for double-sided cutting operations in response to the major axial movement of the second actuator.

15. The system of claim 12, wherein the second actuator is configured to impart a major transverse movement wherein the major transverse movement is substantially orthogonal to the major axial movement.

16. The system of claim 12, wherein the at least one set of fluid bearing comprises a first set of fluid bearings secured at a first location along a length of the cutting element and a second set of fluid bearings secured at a second location along the length of the cutting element.

17. The system of claim 12, wherein a first end of the cutting element is secured to a first tensioning bracket, the first tensioning bracket secured to the first portion of the frame; and wherein a second end of the cutting element is secured to a second tensioning bracket, the second tensioning bracket arranged to slidingly engage the second portion of the frame.

18. The system of claim 12, wherein the cutting element comprises a plurality of layered blades, wherein at least one layered blade of the plurality of layered blades comprises at least one projection and at least one layered blade of the plurality of layered blades comprises a variable width, wherein the variable width changes along a length of the cutting element.

19. The system of claim 12, wherein the system is a low interial system defined by the relationship: M=500e^{-0.004f}+1.216, where M is a combined mass of the frame and cutting element and f is the frequency of vibratory oscillation and wherein M is selected from within the range of 0 kg to 500 kg and f is selected from within the range of 5 Hz to 1000 Hz.

20. The system of claim 12, wherein the system is a low interial system defined by the relationship: M=P/A²4π³f³, where M is the combined mass of the frame and the cutting element A is the displacement of at least the cutting element, P is the power at a tip of the cutting element, and f is the frequency of vibratory oscillation; and
wherein M is selected from within a range of 0 kg to 500 kg; P is selected from within a range between 0 watts and 20 kilowatts; A is selected from within a range between 0 mm and 3 mm; and f is selected from within the range of 5 Hz to 1000 Hz.
